(19) United States
(12) Patent Application Publication
(10) Pub. No.: US 2016/0280506 A1
(43) Pub. Date: Sep. 29, 2016

(54) Curtain Reel Device with Rolling Up and Down Spring Motor

(71) Applicants: Hsien-Te HUANG, Taipei City (TW); Yu-Wei HUANG, Taipei City (TW)

(72) Inventors: Hsien-Te HUANG, Taipei City (TW); Yu-Wei HUANG, Taipei City (TW)

(21) Appl. No.: 15/077,644

(22) Filed: Mar. 22, 2016

(30) Foreign Application Priority Data
Mar. 23, 2015 (TW) 104204351

(51) Int. Cl. B65H 75/48; F16H 1/28; E06B 9/60

(52) U.S. Cl. CPC B65H 75/486; E06B 9/60; F16H 1/28

(57) ABSTRACT

A curtain reel device with rolling up and down spring motor using pull cords to take-up and let-down a horizontal blind set of the blinds. A take-up and let-down motor installed in the interior is provided with a self-feedback operation that operates pull cords for taking up and letting down blinds. A simple coil spring is installed with a reel device, and the inner circumference of a reposition coil formed by the coil spring directly forms an inner annular hub with a fixed diameter by coiling up the end of an elastic sheet band. The inner annular hub is mounted on a pivot shaft joined to side walls to enable movable free rotation thereof. The inner annular hub is in a separation rotational speed relationship with an idler gear coaxially assembled to one end of the pivot shaft, thereby simplifying the structural components of the reel device.

### BACKGROUND OF THE INVENTION

(a) Field of the Invention

The present invention relates to a curtain reel device with rolling up and down spring motor, which provides a reel device with a simple and efficient structural design, whereby when a coil spring repositions, an inner annular hub of fixed diameter is formed directly on the inner circumference of the coil spring by an internal end of a sheet band directly coiling round.

(b) Description of the Prior Art

A drive motor structured from a pressure spring has application in horizontal blinds for taking up and letting down the curtain blinds. When applied in taking up the blinds, since the take-up speed is relatively uniform, a large number of such drive motors have been applied for use in self-feedback take-up curtain blinds with non-exposed pull cords. The drive motor system is provided with a take-up drum and a linkage drum, and the axis of the two are parallel (as shown in FIG. 1). When a coil spring 4 repositions, in order to enable coiling round the outer circumference of a take-up drum 2, a free end of the coil spring 4 is coupled to a drive drum 3. And after being actuated by an external force, the drive drum 3 pulls and coils up the coil spring 4, thereby causing the coil spring 4 to undergo a displacement shift and produce a preparation reposition elastic stress. The elastic stress is defined as the feedback force to prepare for taking up the blinds.

The take-up drum 2 and the drive drum 3 are supported by extruded apertures 11 and a central hub 12 perpendicularly installed to side walls 1 to enable planar rotary motion thereof. The coil spring 4 is formed as a helical-shaped pressure spring. The drive drum 3 is coaxially linked with gear teeth 32, which outwardly mesh with a cord spool 13. A blind pull cord 14 pulls on cord spool 13 in an outward direction to produce rotation thereof, whereupon the rotating motive force is transmitted towards the gear teeth 32, which then drives the drive drum 3, thereby enabling the drive drum 3 to pull and coil up the coil spring 4.

The aforementioned coil spring 4 is pulled and closely coiled onto the external surface of the drive drum 3, and the deformation of the coil spring 4 produces an elastic stress. The elastic stress reserves the feedback force required to take up the blinds. When taking up the blinds, the feedback force produced by the coil spring 4 causes reverse rotation of the cord spool 13 through the gear teeth 32 meshing therewith, thereby causing the cord spool 13 to effect taking up of the pull cord and achieve the purpose of self-takeup of the blinds. Moreover, an elastic response curve of the coil spring 4 is used to effect a uniform pressure effect, which enables a uniform travel speed when taking up the blinds.

The condition between the aforementioned take-up drum 2 and the drive drum 3 is such that the two are axially parallel. However, the linear speed of the coil spring 4 is not uniform because the winding diameter of the coil spring 4 changes during the letting-down and taking-up process, thus, correspondingly, the two circumferential rotation speeds of the take-up drum 2 and the drive drum 3 are out of sync. In order to resolve such a differential rotational speed relationship, and for the internal space of the upper curtain rail to be straight fluted, then U.S. Pat. No. 6,289,965B1 successfully proposed a design that enables producing relative differential rotational speeds of the take-up drum 2 and the drive drum 3, wherein a spring motor design uses extruded apertures 11 perpendicularly installed between parallel corresponding side walls 1, with the outer circumferences of the extruded apertures 11 enabling a central hub 12 to be disposedly mounted thereon. The outer circumference of the central hub 12 further provides an inner circumference 21 of the take-up drum 2 to be pivotal disposed thereon. Accordingly, relative rotation of the take-up drum 2 is formed indirectly through the central hub 12 and between the fixed extruded apertures 11, enabling free selective rotation of the take-up drum 2. One end of each of the extruded apertures 11 is installed with a free rotatable idler gear 5, and the center of the drive drum 3 is supported by lips 120 to enable central rotation through a penetrating disposed structure. Sides of the drive drum 3 are integrally interjoined to flanges 31, and the external surfaces of the flanges 31 are formed with gear teeth 32 parallel to the axis center. The gear teeth 32 and the idler gears 5 are in a mutual meshing relationship.

As for the outer two sides of the aforementioned structure, on one side, the gear teeth 32 further outwardly mesh with a gear wheel coupled to the cord spool 13, and on another side, the idler gears 5 further indirectly interconnect with the gear wheel of another cord spool 13 installed at that side. The cord spool 13 on this side is also in a interconnected relationship with the coaxial gear wheel. Accordingly, the gear teeth 32 of the flanges 31 interconnected to the drive drum 3 singly drive the left side cord spool 13, and indirectly drive the right side cord spool 13 through the idler gears 5. Moreover, each of the gear diameters are equal, thus enabling equal rotational speed of the two side cord spools 13. As for each rotational speed, only that of the take-up drum 2 is different. The take-up drum 2 is responsible for coiling and uncoiling the coil spring 4, and because of the overlap relationship from the thickness of the coil spring 4, changes in the exterior diameter of the coil spring 4 occurs during the coiling and uncoiling thereof. Accordingly, the take-up drum 2 must, through the gap of the central hub 12 and between the extruded apertures 11, produce a free rotation relationship. In principle, the take-up drum 2 is in a mutual separation rotational relationship with the idler gears 5, and overcomes the different circumferential rotational speeds due to the change in diameter during the coiling-uncoiling process of the coil spring 4, enabling equal circumferential rotational speeds of the idler gears 5 and the flanges 31, as well as the two side cord spool 13. Furthermore, equal circumferential rotational speeds of the two side cord spools 13 is maintained to effect uniform take-up and let-down speed of two side pull cords.

In the aforementioned structure, the end of the coil spring 4 wound round the take-up drum 2 must penetrate and fasten onto the outer circumference of the take-up drum 2. The free end must similarly penetrate and fasten onto the radial external surface of the drive drum 3, thereby enabling the coil spring 4 to tightly press close to the take-up drum 2 or the exterior surface of the drive drum 3 when being pulled to effect a coiling and uncoiling action, thereby fundamentally contacting the outer circumference of the take-up drum 2 or the drive drum 3 to maintain activation of the rotational linkage force.

### SUMMARY OF THE INVENTION

The primary object of the present invention lies in providing a curtain reel device with rolling up and down spring motor, comprising a reel device configured with a spring motor, whereby the inner circumference of a coil spring forms an inner annular hub by winding round the internal end of an elastic sheet band to form the inner annular hub with rigid structure and a fixed internal diameter. The inner circumference of the inner annular hub is movable mounted on the external surface of a fixed pivot shaft. One end of the pivot shaft is coaxially joined to an idler gear, and a mutual separation rotational speed relationship is formed between the inner annular hub and the idler gear.

Another object of the present invention lies in the free end of the coil spring being coupled to a drive drum, wherein the drive drum is coaxially linked to a linkage gear. The linkage gear is actuated through an external force and engages the drive drum to continuously pull and coil up the sheet band of the coil spring, finally causing the sheet band to be wound round on the outer circumferential surface of the drive drum, which enables displacement shift of the coil spring. After undergoing a displacement shift, an elastic feedback force occurs, and the linkage gear outwardly directly or indirectly actuates another cord spool. If there are two cord spools installed, then one of them is directly driven by the linkage gear, and the other one is driven by the linkage gear meshing with the idler gear. The cord spools enable the upper ends of the pull cords to wind therearound.

A third object of the present invention lies in a structural method to form the inner annular hub with a rigid body, whereby a spot soldering method is used on the interior of the radial surface of the inner annular hub after a first winding of the sheet band or after an accumulation of multiple windings to rigidly fix the inner annular hub; or a mutual fastening method between a fastening head and a cross-under groove is used to form the single wound inner annular hub after the first winding of the sheet band, or a binding method to rigidly fix and form the inner annular hub is used winding round multiple layers of the sheet band.

A fourth object of the present invention lies in enabling the linkage gear joined to one end of the drive drum to change the rotational speeds of the drive drum and the linkage gear through an amplification mechanism. The rotational speed ratio between the drive drum and the linkage gear is 1:4, thereby enabling amplification of the circumferential rotational speed of the linkage gear. And the amplification mechanism is located in the central interior of the drive drum, and comprises a sun gear, planet gears, and inner annular teeth formed on the inner circumference of the drive drum. The sun gear is coaxially assembled to the linkage gear to form a speed change device for the planetary gear set.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is a structural relationship view of a reel device of the prior art.

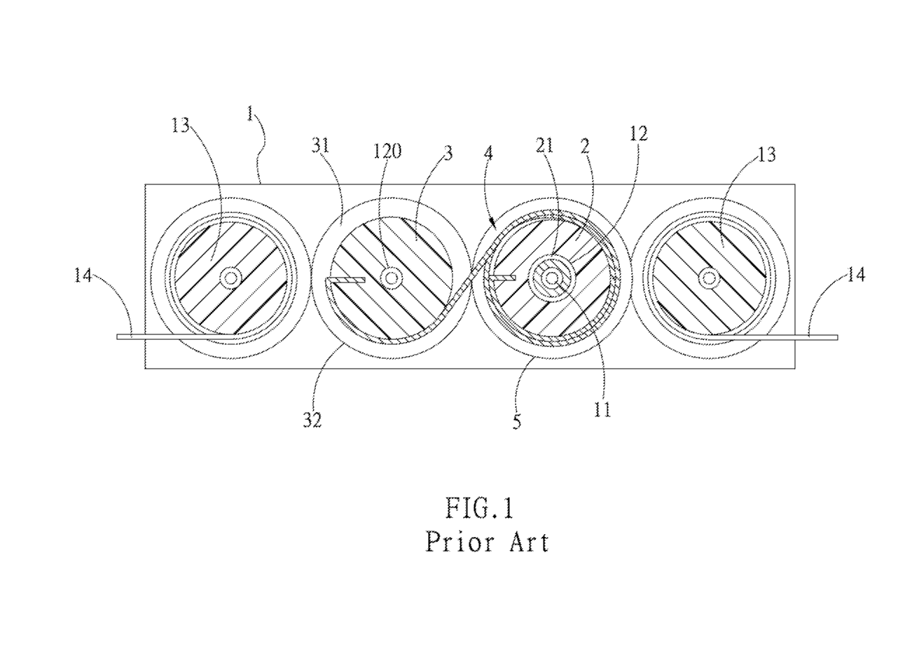

FIG. 2 is an elevational schematic view of a reel device of the present invention.

FIG. 3 is a structural top view of the interior of an embodiment of a spring motor of the present invention.

FIG. 4 is a schematic view depicting winding round of a spring sheet band to form an inner annular hub according to the present invention.

FIG. 5 is another schematic view depicting winding round of the spring sheet band to form the inner annular hub according to the present invention.

FIG. 6 is a side view of an amplification mechanism configured between an assemblage of a drive drum and linkage gears according to the present invention.

FIG. 7 is an elevational schematic view of the structure depicted in FIG. 6.

### DETAILED DESCRIPTION OF THE PREFERRED EMBODIMENTS

A curtain reel device with rolling up and down spring motor of the present invention primarily comprises a central inner circumference of a coil spring used to form an inner annular hub by integrally extending a sheet band to directly form the inner annular hub with a fixed internal diameter measurement, which is an upright cylindrical form with a rigid structure. The inner annular hub is freely movable mounted on the fixed outer circumference of a pivot shaft. In addition, there is a separation rotational speed relationship between the inner annular hub and an idler gear coaxially installed on the pivot shaft.

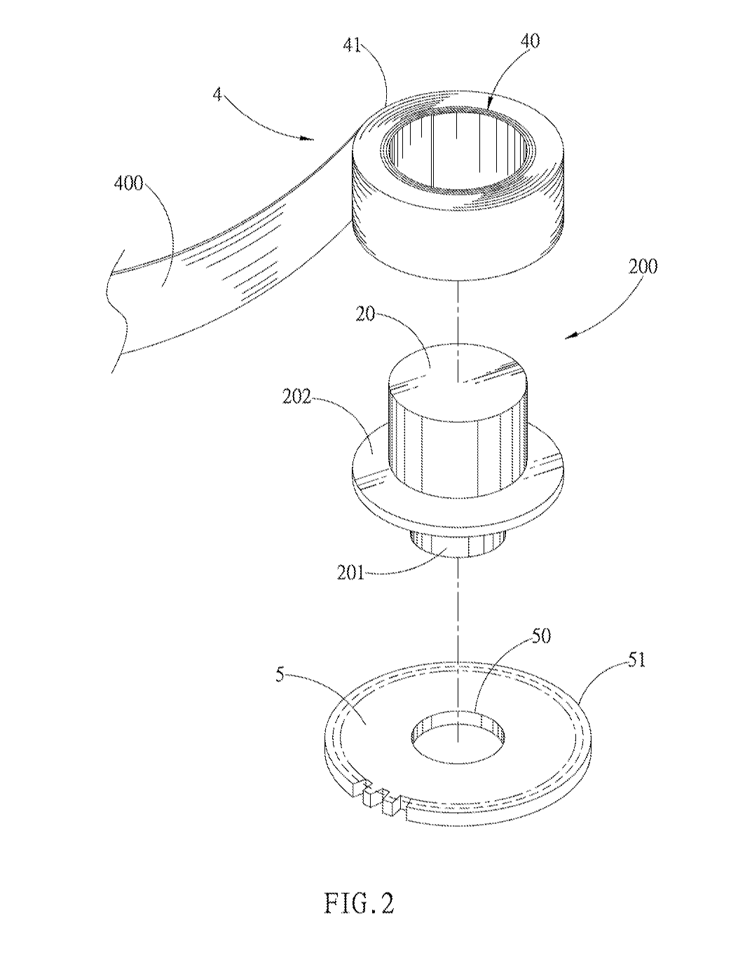

Regarding the detailed specification and structural means of the present invention, please refer to the description of the diagrams as follows. Referring first to FIG. 2.

A reel device 200 installed in the present invention comprises a coil spring 4 coaxially assembled to the outer circumference of a pivot shaft 20. One end of the pivot shaft 20 is coaxially assembled with an idler gear 5, wherein at least one end of the pivot shaft 20 is fitted with a disk 202. The disk 202 facilitates the coil spring 4 to achieve a horizontal position requirement when actuated, and one end of the pivot shaft 20 is extended to form a supporting shaft 201. After assembling the supporting shaft 201 in a shaft hole 50 provided at the center of the idler gear 5, disposition of the supporting shaft 201 enables the idler gear 5 to freely rotate thereon, and the pivot shaft 20 in the embodiment of the invention can be fixed. Gear teeth 51 on the outer circumference of the idler gear 5 form a meshing direction axially perpendicular to the pivot shaft 20. The coil spring 4 is a coiled structure formed from a sheet band 400, which in a static state forms a reposition coil 41. The inner circumference of the reposition coil 41 uses an internal end of the sheet band 400 to directly conjoin and form a rigid inner annular hub 40 with a fixed internal diameter.

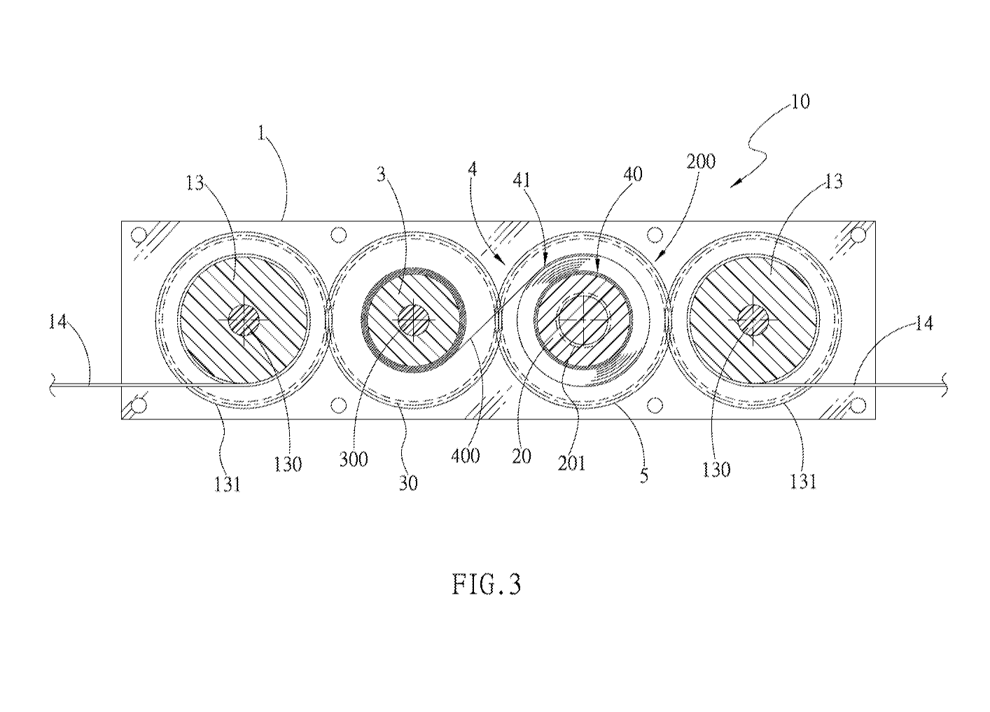

Referring to FIG. 3, which shows the interior of a spring motor 10 with the embodiment of the reel device 200, wherein the pivot shaft 20 and a working end shaft 300 are respectively perpendicular assembled between upper and lower two side correspondingly parallel side walls 1 of the spring motor 10. The outer circumferential surface of the shaft body of the working end shaft 300 provides the inner circumference of a drive drum 3 to be movable pivotal disposed thereon, and one end of the drive drum 3 is axially coupled to a linkage gear 30.

The outer circumference of the pivot shaft 20 enables the inner circumference of the inner annular hub 40 formed in the interior of the coil spring 4 to be movable pivotal disposed thereon. One end of the pivot shaft 20 is installed with the retractible supporting shaft 201, which enables the idler gear 5 to be movable assembled thereon. The idler gear 5 and the pivot shaft 20 are in a movable relationship, which enables the idler gear 5 to be a completely free body. The idler gear 5 and the linkage gear 30 the two are in a meshing relationship.

In the assembly of the reel device 200, the inner circumference of the inner annular hub 40 of the coil spring 4 is axially movable mounted on the outer circumference of the pivot shaft 20. When in a static state, because of the elastic stress in the sheet band 400 of the coil spring 4, the sheet band 400 coils up towards one end of the inner annular hub 40 in a self-coiling manner to form the reposition coil 41. The other exposed end of the sheet band 400 is joined to the outer circumferential surface of the drive drum 3 in preparation to be pulled and coiled up on the drive drum 3.

When the drive drum 3 rotates and pulls the sheet band 400 to wind round the outer circumference of the drive drum 3, because of the thickness of the sheet band 400, the external diameter of the entire coiled-up sheet band 400 changes according to the number of turns of winding the sheet band 400. Accordingly, as the drive drum 3 sequentially pulls and coils up the sheet band 400, the external diameter of the winding of sheet band 400 increases because of the overlapping of the layers thereof. Hence, under the condition that the external force operating the rotational speed of the linkage gear 30 is constant, then the speed of the sheet band 400 being pulled gradually increases, and the rotational speed of the inner annular hub 40 increases accordingly. In addition, the linkage gear 30 and the idler gear 5 are in a synchronous meshing relationship, moreover, the linkage gear 30 and the drive drum 3 are coaxially interconnected with equal rotational speed, thus, there must be a rotational speed difference between the inner annular hub 40 and the idler gear 5. The rotational speed separation relationship between the two uses the inner circular hole of the inner annular hub 40 to movable pivotal dispose on the outer circumference of the pivot shaft 20, thereby separating the rotational speed relationship between the inner annular hub 40 and the idler gear 5.

The present invention uses the inner circumference of the coil spring 4 to directly form the inner annular hub 40, which is then movable pivotal disposed on the outer circumference of the pivot shaft 20 to form a movable relationship between the two, thereby enabling the idler gear 5 and the pivot shaft 20 to be coaxially interconnected. Moreover, because of the movable relationship between the inner circumference of the inner annular hub 40 and the outer circumference of the pivot shaft 20, thus, rotational speeds between the inner annular hub 40 and the the idler gear 5 are similarly separated.

Using the aforementioned structure enables separating the rotational speeds of the inner annular hub 40 and the idler gear 5, thereby facilitating synchronous rotation of the idler gear 5 and the linkage gear 30. In a further embodiment of the spring motor 10 whereby, in order to pair up with the straight channel of the internal space of a horizontal rail of general curtain blinds (not shown in the drawings), the spring motor 10 can be manufactured to be a strip-shaped module. Furthermore, sides external to the linkage gear 30 and the idler gear 5 are front and rear aligned with parallel shafts 130. The shafts 130 respectively enable the inner circumferences of two side cord spools 13 to be movable pivotal disposed on. One end of each of the cord spools 13 is coaxially coupled to a driven gear 131, thereby enabling the cord spools 13 and the driven gears 131 to be in coaxially linked relationships.

The two side driven gears 131 mesh with the linkage gear 30 and the idler gear 5, respectively. Accordingly, actuation of the linkage gear 30 synchronously drives the idler gear 5 and the two side driven gears 131. Under the condition whereby actuation of the linkage gear 30 and the idler gear 5, and the working diameters of the meshing of the two side driven gears 131 are equal, then the rotational speeds of the two driven gears 131 are equal, which facilitates uniform travel speed of pull cords 14 when taking up and letting down blinds.

Using the inner circumference of the reposition coil 41 of the coil spring 4 installed on the reel device 200 to directly form the inner annular hub 40 with fixable diameter, the internal inside diameter of the inner annular hub 40 is slightly larger than the diameter of the surface of the pivot shaft 20, thereby forming a free gap. And using this gap enables free rotation of the inner annular hub 40, thereby simplifying the structure of the reel device 200. Furthermore, using the sheet band 400 of the coil spring 4 to integrally extend and form the inner annular hub 40 on the inner circumference of the reposition coil 41, then an integral body coupling relationship is formed between the inner annular hub 40 and the reposition coil 41, hence, the inner annular hub 40 consists of the same material as that of the sheet band 400, with firm and tenacious properties, and thus not easily damaged.

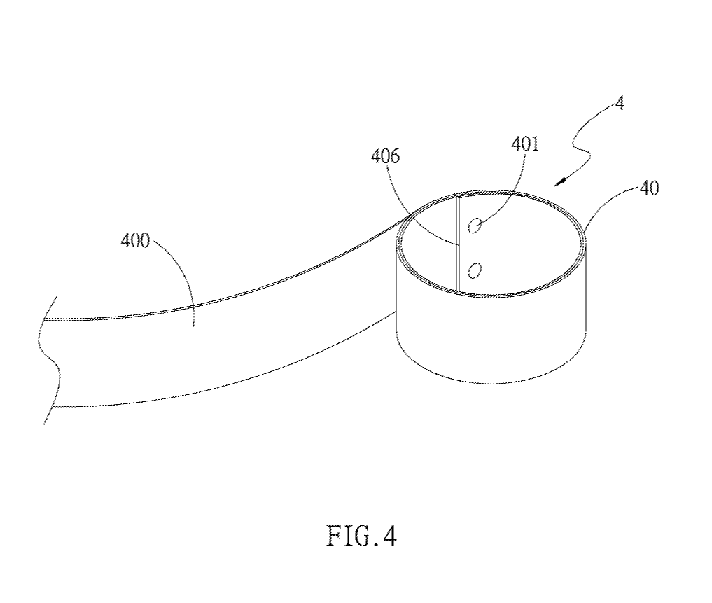

Referring to FIG. 4, which shows the method by which the sheet band 400 of the coil spring 4 is wound round to form the inner annular hub 40, wherein soldering points 401 are point soldered along the breadth of the innermost winding of the sheet band 400 to form the inner annular hub 40. The soldering points 401 penetrate the inner and outer layers of the inner annular hub 40. And the inner annular hub 40 uses winding up of the sheet band 400 to produce a multi-wound (multi-layer) form, whereupon soldering of the soldering points 401 enables a cross section of the inner annular hub 40 to have a greater thickness, with the greater thickness increasing the strength of the inner annular hub 40.

The inner circumferential diameter of the inner annular hub 40 is uniformly circular, and, in principle, the establishment of the soldering points 401 should not affect the inner circumferential diameter of the inner annular hub 40. In addition, regarding the sheet band 400 wound round to form the inner annular hub 40, because the thickness of the sheet band 400 is extremely thin, thus, a side end 406 of the innermost winding will not distinctly affect the out of roundness of the inner circumference of the inner annular hub 40. If the end opening thickness of the side end 406 can be made to be even finer through a modular approach, and the gap between the inner circumferential diameter of the inner annular hub 40 and the outer circumferential diameter of the aforementioned pivot shaft 20 (with reference to FIG. 3) can be made to be a relatively larger spacing, then the side end 406 will not affect movable relationship between the inner annular hub 40 and the outer circumferential surface of the pivot shaft 20.

The inner annular hub 40 formed by the coil spring 4 is produced by winding round one end of the sheet band 400, whereby using at least one winding of one end of the sheet band 400 enables obtaining the existence of the inner annular hub 40 that extends and is joined to the sheet band 400. The inner annular hub 40 can also be produced from a single winding of the sheet band 400.

Multiple layers of the sheet band 400 can also be used to form the inner annular hub 40, wherein an agglutinate means can also be used to form the inner annular hub 40, whereby an agglutinant is spread on the surface of each winding of the overlapping layers, and after curing, an accumulation of multiple layers of windings is obtained to form the thick inner annular hub 40.

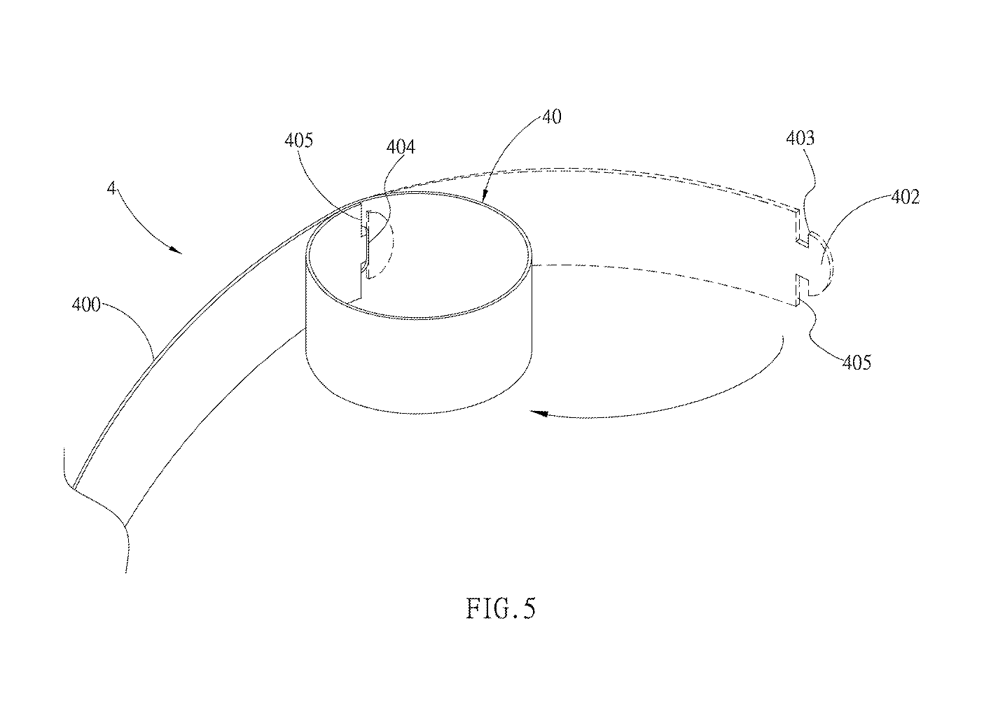

Referring to FIG. 5, which shows the inner annular hub 40 of the coil spring 4 formed by winding round the internal end of the sheet band 400, wherein one end of the winding of the sheet band 400 is provided with a fastening head 402. The fastening head 402 is provided with an inverse fastening tooth 403 and retaining shoulders 405. After inwardly winding the sheet band 400 until the fastening head 402 reaches a cross-under groove 404 provided in an area of the body of the sheet band 400, then the elastic deformation force of the fastening head 402 is used to enable the fastening head 402 to pass through the cross-under groove 404. After passing through the cross-under groove 404, the inverse fastening tooth 403 configured on the fastening head 402 is then used to inverse fasten into the upper, and lower side ends of the cross-under groove 404, thereby preventing the inner circumferential diameter of the inner annular hub 40 from enlarging. Furthermore, the relatively greater width of the retaining shoulders 405 compared to the upper and lower side ends of the cross-under groove 404 is used to disable the retaining shoulders 405 from passing through the cross-under groove 404, thereby obtaining a minimum limitation of the internal diameter of the inner annular hub 40.

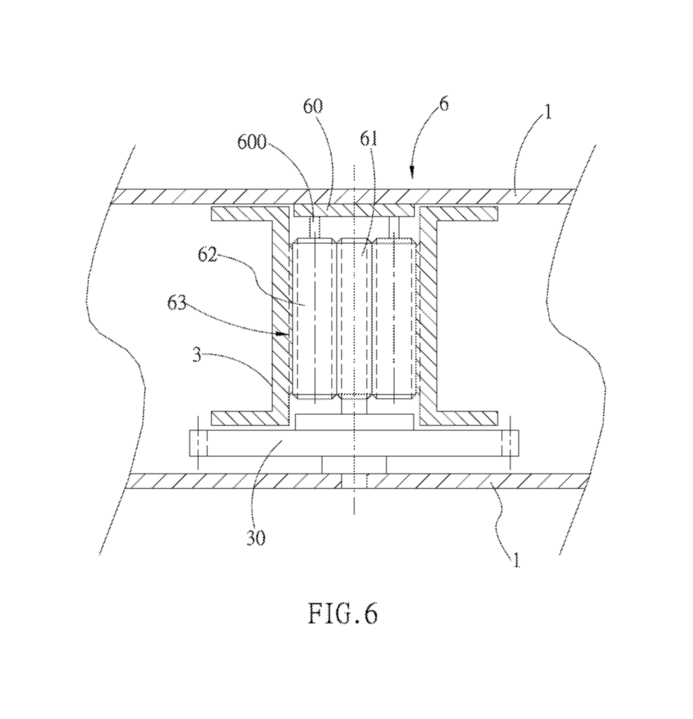

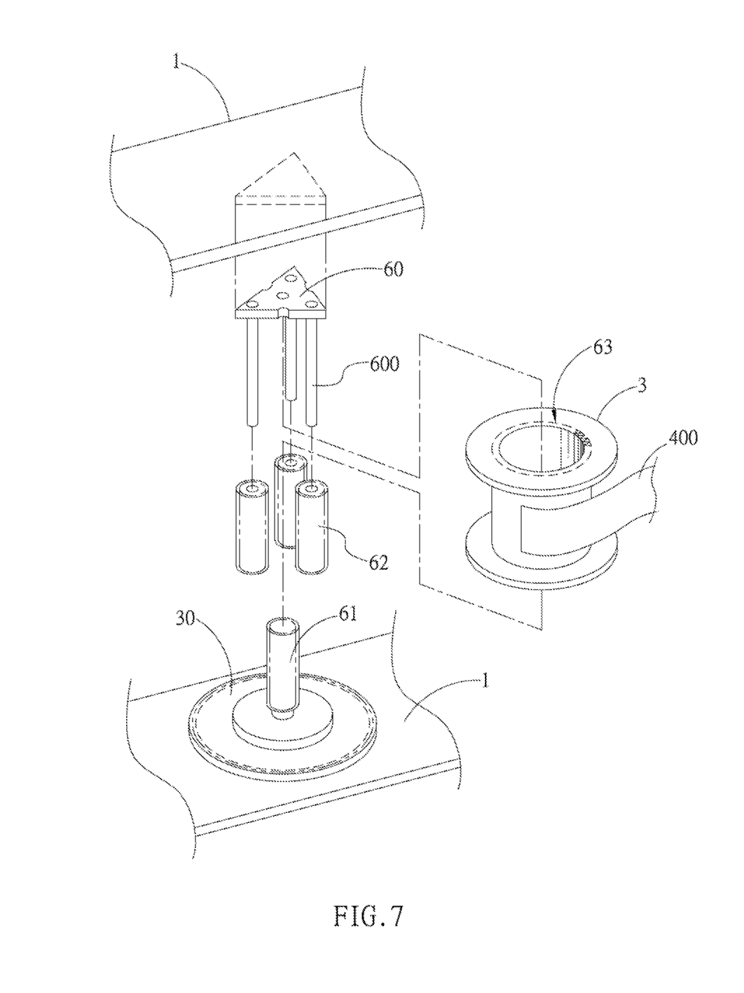

Referring to FIGS. 6 and 7, in principle, the embodiment of the drive drum 3 is in a synchronous linkage relationship with the linkage gear 30, and under conditions in order to slow down the pulling speed on the coil spring 4 (with reference to FIG. 3), or to increase the elastic stress of the sheet band 400 (with reference to FIG. 3), the speed ratio relationship between the drive drum 3 and the linkage gear 30 can be changed to 1:4, thereby amplifying the rotational speed of the linkage gear 30.

In the aforementioned embodiments, an amplification mechanism 6 can be assembled between the axial direction of the drive drum 3 and the linkage gear 30, and the amplification mechanism 6 is used to change the two rotational speeds thereof. An embodiment of the amplification mechanism 6 can adopt the concept of a planetary gear set, wherein a sun gear 61 is integrally coupled on the axis of the linkage gear 30. A planet base 60 is fixedly joined to the interior of the offside side walls 1, and planet gears 62 are respectively movable pivotal disposed to the planet base 60 through shaft rods 600. There are more than one of the planet gears 62, which are supported by the shaft rods 600 to centrally rotate. In addition, inner annular teeth 63 are formed on the inner circumference of the drive drum 3. Accordingly, rotating the drive drum 3 enables the inner annular teeth 63 on the interior thereof to mesh with the planet gears 62. Because the axis positions of the planet gears 62 are fixed by the planet base 60, hence, the smaller internal diameter of the planet gears 62 compared to the inner annular teeth 63 is used to enable amplification of the rotational speed of the planet gears 62. The planet gears 62 then centrally mesh with the sun gear 61, whereupon the speeding-up effect of the planet gears 62 increases rotational speed of the sun gear 61, and synchronously increases the rotational speed of the linkage gear 30.

The present invention uses the coil spring 4 formed by the sheet band 400, whereby in a static state, the inner circumference of the reposition coil 41 forms the inner annular hub 40. The inner circumferential diameter of the inner annular hub 40 is slightly larger than that of the pivot shaft 20, thereby freeing a movable gap between the external surface of the pivot shaft 20 and inner circumferential diameter of the inner annular hub 40, and allowing the rotational speed of the inner annular hub 40 to be independent of the pivot shaft 20, thus simplifying the structural embodiment of the reel device 200. Accordingly, the present invention is truly an innovative design.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A curtain reel device with rolling up and down spring motor, comprising:
a set of corresponding side walls, a pivot shaft and a working end shaft are perpendicularly installed between the corresponding side walls;
an idler gear, the idler gear is coaxially movable assembled on one end of the pivot shaft;
a drive drum, the drive drum is coaxially joined to a linkage gear, center of rotation is supported by the working end shaft, the linkage gear and the idler gear are in a meshing relationship;
a coil spring, a free end of the coil spring is coupled to an outer circumferential surface of the drive drum, integrally extending an inner circumference of a reposition coil configured from the coil spring and inwardly winding a sheet band produces an inner annular hub with a fixed inner circumferential diameter, the inner annular hub is movable pivotal disposed on an outer circumferential surface of the pivot shaft.

2. The curtain reel device with rolling up and down spring motor according to claim 1, wherein the inner annular hub is produced by integrally extending an internal end of the sheet band and winding round multiple windings thereof.

3. The curtain reel device with rolling up and down spring motor according to claim 2, wherein the inner annular hub is made up from multiple windings, an agglutination method is used to fix between multiple layers of the multiple windings.

4. The curtain reel device with rolling up and down spring motor according to claim 1, wherein the inner annular hub is produced by integrally extending an internal end of the sheet band and winding round thereof, and a configuration of inner and outer windings is fixed by soldering points that directly penetrate the inner and outer windings.

5. The curtain reel device with rolling up and down spring motor according to claim 1, wherein an end of the sheet band is provided with a fastening head, the fastening head coils round and fastens into a cross-under groove provided in one area of body of the sheet band, and such a fastening method is used to form the inner annular hub.

6. The curtain reel device with rolling up and down spring motor according to claim 1, wherein diameters of the linkage gear and the idler gear are equal.

7. A curtain reel device with rolling up and down spring motor, comprising:
a set of corresponding side walls, two pivot shafts and working end shafts are perpendicularly installed between the corresponding side walls;
idler gears, the idler gears are coaxially movable assembled on ends of the pivot shafts;
a drive drum, the drive drum is coaxially joined to a linkage gear with same diameter as the idler gears, center of rotation is supported by the working end shafts, the linkage gear and the idler gears are in a meshing relationship;
a coil spring, a free end of the coil spring is coupled to an outer circumferential surface of the drive drum, integrally extending an inner circumference of a reposition coil configured from the coil spring and inwardly winding a sheet band produces an inner annular hub with a fixed inner circumferential diameter, the inner annular hub is movable pivotal disposed on the outer circumferential surface of the pivot shaft; two shafts, perpendicularly installed on interior of the surfaces of the corresponding side walls, the two shafts are arranged on an outer side positions of the pivot shafts and the working end shafts, axis and the pivot shafts and axis of the working end shafts are parallel;
two cord spools, one end of each of the cord spools is respectively coaxially fixedly joined to driven gears of equal diameter, an outer circumference of the cord spools enables a curtain pull cord to wind therearound, and centers of the cord spools are respectively supported by the working end shafts, the two driven gears respectively mesh with the linkage gear and the idler gears.

8. The curtain reel device with rolling up and down spring motor according to claim 7, wherein the inner annular hub is produced by integrally extending an internal end of the sheet band and winding round multiple windings thereof.

9. The curtain reel device with rolling up and down spring motor according to claim 8, wherein the inner annular hub is made up from multiple windings, and an agglutination method is used to fix between multiple layers of the multiple windings.

10. The curtain reel device with rolling up and down spring motor according to claim 7, wherein the inner annular hub is produced by integrally extending an internal end of the sheet band and winding round thereof, and a configuration of inner and outer windings is fixed by soldering points that directly penetrate the inner and outer windings.

11. The curtain reel device with rolling up and down spring motor according to claim 7, wherein an end of the sheet band is provided with a fastening head, the fastening head coils round and fastens into a cross-under groove provided in one area of body of the sheet band, and such a fastening method is used to form the inner annular hub.

12. The curtain reel device with rolling up and down spring motor according to claim 1, wherein an amplification mechanism is assembled between the drive drum and the linkage gear, and the amplification mechanism joined to axis line position of drive drum is used to change rotational speeds of the drive drum and the linkage gear, the rotational speed ratio therebetween is such that the rotational speed of the linkage gear is greater than the drive drum.

13. The curtain reel device with rolling up and down spring motor according to claim 7, wherein an amplification mechanism is assembled between the drive drum and the linkage gear, and the amplification mechanism joined to axis line position of drive drum is used to change rotational speeds of the drive drum and the linkage gear, the rotational speed ratio therebetween is such that the rotational speed of the linkage gear is greater than the drive drum.

14. The curtain reel device with rolling up and down spring motor according to claim 12, wherein the amplification mechanism comprises:
a sun gear, the sun gear is coaxially joined to the linkage gear;
a set of shaft rods, the shaft rods are fixedly positioned to the side wall through a planet base;
a set of planet gears, centers of the planet gears rotate by means of pin connections with the shaft rods, and the planet gears centrally mesh with the sun gear;
the drive drum, inner annular teeth are formed on inner circumference of the drive drum, and the inner annular teeth mesh with the planet gears.

15. The curtain reel device with rolling up and down spring motor according to claim 13, wherein the amplification mechanism comprises:
a sun gear, the sun gear is coaxially joined to the linkage gear;
a set of shaft rods, the shaft rods are fixedly positioned to the side wall through a planet base;
a set of planet gears, centers of the planet gears rotate by means of pin connections with the shaft rods, and the planet gears centrally mesh with the sun gear;
the drive drum, inner annular teeth are formed on inner circumference of the drive drum, and the inner annular teeth mesh with the planet gears.
